(19) United States
(12) Patent Application Publication
(10) Pub. No.: US 2014/0181657 A1
(43) Pub. Date: Jun. 26, 2014

(54) PORTABLE DEVICE AND AUDIO CONTROLLING METHOD FOR PORTABLE DEVICE

(71) Applicant: HON HAI PRECISION INDUSTRY CO., LTD., New Taipei (TW)

(72) Inventor: CHIH-CHUN CHANG, New Taipei (TW)

(73) Assignee: HON HAI PRECISION INDUSTRY CO., LTD., New Taipei (TW)

(21) Appl. No.: 14/016,416

(22) Filed: Sep. 3, 2013

(30) Foreign Application Priority Data
Dec. 26, 2012 (TW) 101149979

(51) Int. Cl. G06F 3/16

(52) U.S. Cl. CPC G06F 3/165
USPC 715/716

(57) ABSTRACT

A portable device communicating with an electronic device to receive audio dedicated to one display which is one of a number of simultaneous displays on the electronic device comprises a communicating module, a selection module, and an audio outputting module. The electronic device provides a number of displays in different parts of a screen, each with an associated audio, and transmits one associated audio to the portable device. The communicating module allows the portable device to communicate with the electronic device. The selection module selects one display as the preferred display according to an operation of user and controls the electronic device to transmit the audio associated with the preferred display to portable device. The audio outputting module outputs the associated audio of the selected display on the portable device. An audio controlling method applied to the portable device is also provided.

### BACKGROUND

1. Technical Field

The present disclosure relates to a portable device outputting audio of a preferred display area displayed on an electronic device in communication with the portable device.

2. Description of Related Art

Large display elements, such as TVs, can simultaneously display a number of images from different signal sources for being watched by a number of users, and each video or TV channel has an audio output. However, outputting audio to satisfy the requirements of several different current users is problematic.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the portable device and audio controlling method thereof. Moreover, in the drawings, like reference numerals designate corresponding parts throughout the several views.

FIG. 1 is a block diagram of a portable device communicating with an electronic device in accordance with an embodiment.

FIG. 2 is a schematic diagram showing a number of display areas of the electronic device of FIG. 1 in accordance with an embodiment.

FIG. 3 is a schematic diagram showing a display region of FIG. 2 with an adjustment interface.

FIG. 4 is a flowchart of an audio controlling method implemented by the portable device of FIG. 1 in accordance with an embodiment.

### DETAILED DESCRIPTION

In general, the word “module,” as used herein, refers to logic embodied in hardware or firmware, or to a collection of software instructions, written in a programming language, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

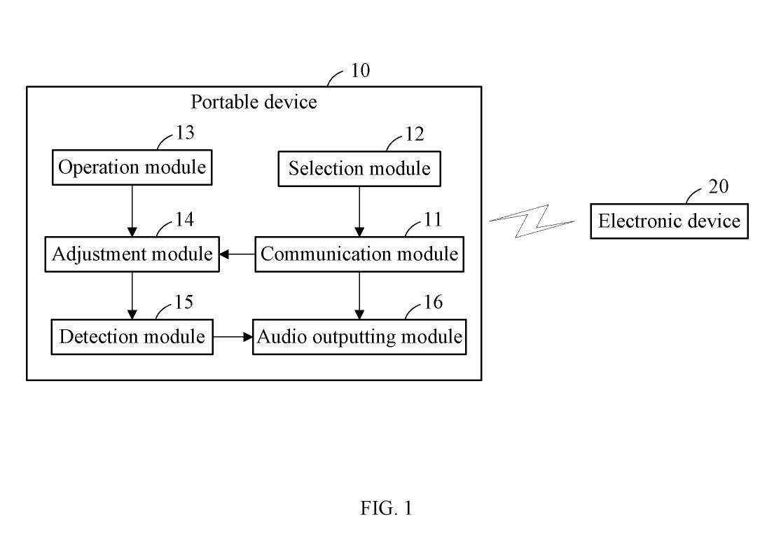

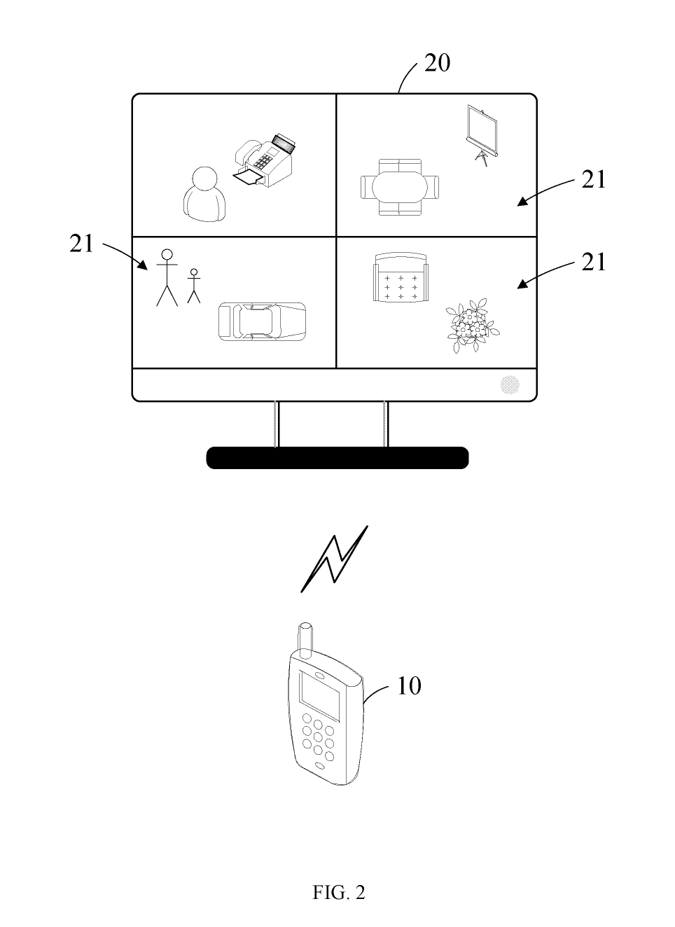

FIGS. 1 and 2 show a portable device 10 and an electronic device 20 of an embodiment. The portable device 10 communicates with the electronic device 20. The electronic device 20 provides a number of display areas 21 for simultaneous different displays each of which is from different video/audio signal sources and outputs audio associated with a preferred display area. The electronic device 20 can communicate with a number of portable devices 10 simultaneously, and transmit audio associated with a selected display area for output by portable devices 10 which is different with the preferred display area. Each associated audio can include different soundtracks in different languages, such as a default soundtrack and a dubbing soundtrack. In the embodiment, the portable device 10 is a mobile phone; the electronic device 20 can be a television or a computer, for example.

The portable device 10 includes a communication module 11, a selection module 12, an operation module 13, an adjustment module 14, a detection module 15, and an audio outputting module 16.

By user operation, the communication module 11 establishes a data connection with the electronic device 20. In the embodiment, the communication module 11 connects with the electronic device 20 wirelessly. In other embodiments, the communication module 11 connects with the electronic device 20 by wires.

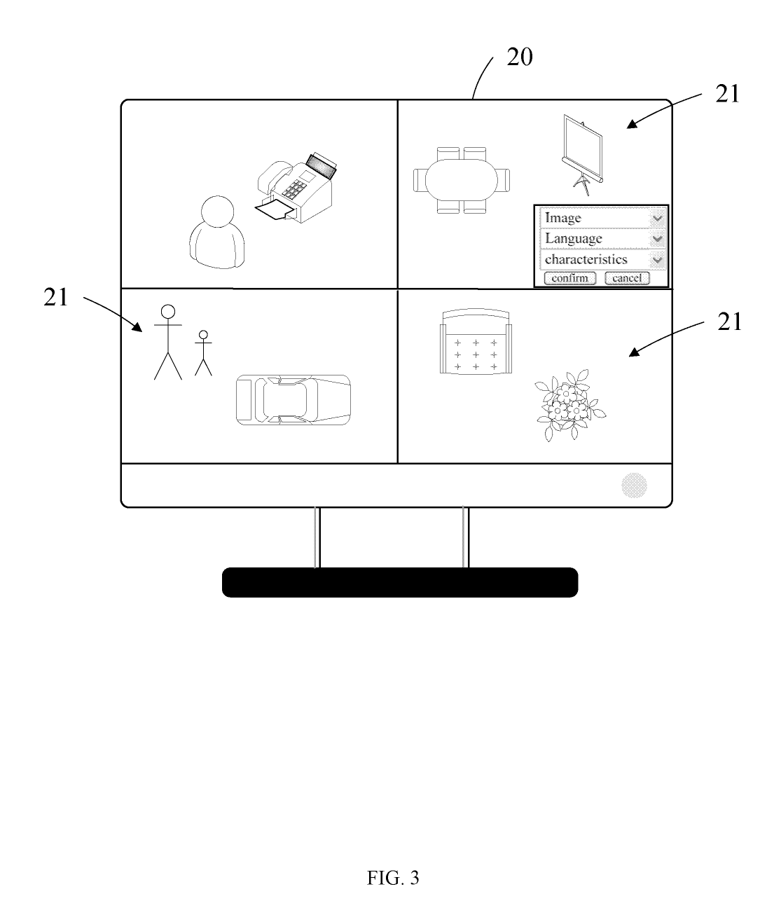

The selection module 12 selects one of the display areas 21 in response to the operation of user, and controls the electronic device 20 to transmit the associated audio of the selected display area to the portable device 10. The selection module 12 further controls the electronic device 20 to display an adjustment interface in the selected display area in a picture-in-picture manner (as shown in FIG. 3). The adjusting interface includes a number of dropdown lists. Each of the dropdown lists includes a number of the options. In the embodiment, the dropdown lists includes an image adjusting item, a display characteristics item, and a language adjusting item. In the other embodiments, the adjustment interface can be displayed on the portable device 10.

The communication module 11 further receives the associated audio from the electronic device 20.

The operation module 13 generates signals in response to the adjustments made by users. The adjustment signals include an image adjustment signal, a display characteristics adjustment signal, and a language adjustment signal including a selected language.

The adjustment module 14 adjusts the selected display area in response to the adjustment signal. When the adjustment signal is the image adjustment signal, the adjustment module 14 controls the selected display area to display images of the portable device 10. When the adjustment signal is the display characteristics adjustment signal, the adjustment module 14 adjusts the display characteristics of the selected display area on the electronic device 20. In the embodiment, the display characteristics of the selected display area include colors, brightness, and grayness degree, and the like. When the adjustment signal is the language adjustment signal, the adjustment module 14 generates a detection signal.

The detection module 15 detects whether the received audio includes a soundtrack in the selected language in response to the detection signal. When the received audio includes a soundtrack in the selected language, the detection module 15 switches within the received audio to the soundtrack in the selected language. When the received audio does not include a soundtrack in the selected language, the detection module 15 can translates the received audio into the selected language by online means.

The audio outputting module 16 outputs the associated audio. In the embodiment, the audio outputting module 16 is an earphone. In other embodiments, the audio outputting module 16 can be a speaker of the portable device 10.

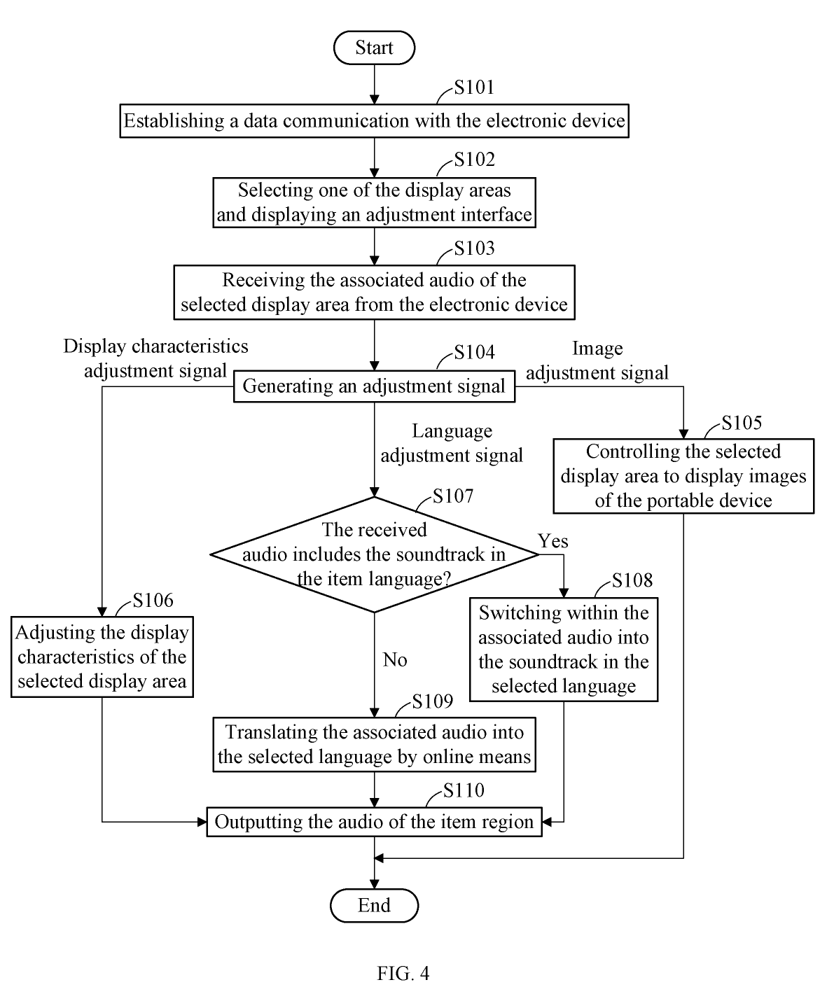

FIG. 4 shows an audio controlling method for a portable device 10 to output audio associated with a selected display. The electronic device 20 provides a number of display areas 21 for different simultaneous displays which are from different video/audio signal sources, and outputs audio associated with a preferred display area. The electronic device 20 can communicate with a number of portable devices 10 simultaneously, and transmit the associated audio with the selected display area for output by portable device 10 which is different with the preferred display area. Each associated audio can include different soundtracks in different languages, such as a default soundtrack and a dubbing soundtrack. The audio controlling method includes the following steps.

In step S101, the communicating module 11 establishes a communication with the electronic device 20. In the embodiment, the communication module 11 connects with the electronic device 20 wirelessly. In other embodiments, the communication module 11 connects with the electronic device 20 by wires.

In step S102, the selection module 12 selects one of the display areas 21 in response to the operation of user and controls the electronic device 20 to display an adjustment interface in the selected display area in a picture-in-picture manner (as shown in FIG. 3). The adjusting interface includes a number of dropdown lists. Each of the dropdown lists includes a number of options. In the embodiment, the dropdown lists includes an image adjusting item, a display characteristics item, and a language adjusting item including a selected language. In the other embodiments, the adjustment interface can be displayed on the portable device 10.

In step S103, the communication module 11 receives the associated audio from the electronic device 20.

In step S104, the operation module 13 generates different adjustment signals in response to user operation on the adjusting interface. If the adjustment signal is an image adjustment signal, the procedure goes to S105; if the adjustment is a display characteristics adjustment signal, the procedure goes to S106; if the adjustment signal is a language adjustment signal, the procedure goes to S107.

In step S105, the adjustment module 14 controls the selected display area to display images of the portable device 10.

In step S106, the adjustment module 14 adjusts the display characteristics of the selected display area. The display characteristics of the selected display area include brightness, color, and grayness degree, and the like.

In step S107, the detection module 15 detects whether the received audio includes a soundtrack in the selected language. If the received audio includes a soundtrack in the selected language, the procedure goes to S108; if the received audio does not include a soundtrack in the selected language, the procedure goes to S109.

In step S108, the detection module 15 switches within the associated audio to the soundtrack in the selected language.

In step S109, the detection module 15 translates the associated audio into the selected language by online means.

In step S110, the audio outputting module 16 outputs the associated audio. In the embodiment, the audio outputting module 16 is an earphone. In other embodiments, the audio outputting module 16 can be a speaker of the portable device 10.

In use, the portable device 10 can output the audio and the type of audio to the exact requirements of users; such that the requirements of different users can be simultaneously satisfied without changing the output to other users of the electronic device 20.

While various embodiments have been described, the disclosure is not to be limited thereto. Various modifications and similar arrangements (as would be apparent to those skilled in the art) are also intended to be covered. Therefore, the scope of the appended claims should be accorded the broadest interpretation so as to encompass all such modifications and similar arrangements.

What is claimed is:

1. A portable device capable of communicating with an electronic device, the electronic device displaying a number of display areas each with an associated audio; the portable device comprising:
a communicating module establishing a data communication with the electronic device;
an selection module selecting one of the display areas in response to an operation of users and controlling the electronic device to transmit the associated audio of the selected display area to the portable device; and
an audio outputting module outputting the audio of the selected display area transmitted from the electronic device.

2. The portable device of claim 1, further comprising an operation module and an adjustment module, wherein the operation module generates different adjustment signals in response to operation of users; the adjustment module adjusts the selected display area in response to the adjustment signal.

3. The portable device of claim 2, wherein the adjustment signals comprises an image adjustment signal; the adjustment module controls the electronic device to controls the selected display area to display images of the portable device in response to the image adjustment signal.

4. The portable device of claim 2, wherein the adjustment signals comprises a display characteristics adjustment signal; the adjustment module adjusts the display characteristics of the selected display area in response to the display characteristics adjustment signal; the display characteristics include brightness, color, and grayness degree.

5. The portable device of claim 2, further comprising a detection module, wherein each of the associated audio includes different soundtracks in different languages; the adjustment signals comprises a language adjustment signal including a selected language; the adjustment module further generates a detection signal in response to the language adjustment signal; the detection module detects whether the received audio includes a soundtracks in the selected language in response to the detection signal; when the received audio includes a soundtrack in the selected language, the detection module switches within the associated audio to the soundtrack in the selected language.

6. The portable device of claim 5, wherein when the received audio does not include a soundtrack in the selected language, the detection module translates the associated audio into the selected language by online means.

7. The portable device of claim 2, wherein the selection module further controls the electronic device to display an adjustment interface in the selected display area with a plurality of dropdown lists.

8. An audio controlling method for a portable device to communicate with an electronic device; the electronic device displaying a number of display areas with an associated audio; the audio controlling method comprising:
establishing a data communication between the portable device and the electronic device;
selecting one of the display areas in response to an operation of users;
receiving the associated audio of the selected display area from the electronic device; and
outputting the audio of the selected display area.

9. The method of claim 8, further comprising:
displaying an adjustment interface on the selected display area;
generating adjustment signal according to operation of users; and
adjusting the selected display area in response to the adjustment signal.

10. The method of claim 9, further comprising: controlling the selected display area to display images of the portable device when the adjustment signal is an image adjustment signal.

11. The method of claim 9, further comprising: adjusting the display characteristics of the selected display area when the adjustment signal is a display characteristics adjustment signal.

12. The method of claim 11, wherein the display characteristics comprises brightness, color, and gray degree.

13. The method of claim 9, wherein each of the associated audio comprises different soundtrack in different languages, when the adjustment signal is a language adjustment signal including a selected language the adjusting step further comprising:
detecting whether the associated audio includes a soundtrack in a selected language; and
switching within the associated audio to the soundtrack with the selected language when the received audio includes a soundtrack in the selected language.

14. The method of claim 13, further comprising: translating the received audio into the selected language by online means when the received audio does not include a soundtrack in the selected language.

15. The method of claim 9, wherein the selected display area comprises an adjusting interface with a number of dropdown lists.
